(19) United States
(12) Patent Application Publication
(10) Pub. No.: US 2008/0020642 A1
(43) Pub. Date: Jan. 24, 2008

(54) Electrical connector having improved inner shileding plate

(75) Inventor: Feng Pan, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/879,660

(22) Filed: Jul. 18, 2007

(30) Foreign Application Priority Data
Jul. 18, 2006 (CN) 200620075221.6

(51) Int. Cl. H01R 13/648

(52) U.S. Cl. 439/607

(57) ABSTRACT

An electrical connector (100) mounted on a printed circuit board includes an insulative housing (10) defining a number of terminal slots (141, 151), a number of terminal modules (20), an outer shield (40) attached to the insulative housing and a number of inner shielding plates (30) each disposed between two adjacent terminal modules. The outer shield has a first wall (41) and a second wall (42) extending downwardly from the first wall. The inner shielding plate has a first section (31) and a second section (34) engaging with the first wall and the second wall, respectively. At least one of the first section and the second section includes a spring portion (312) flexibly engaging with corresponding wall of the outer shield.

### BACKGROUND OF THE INVENTION

1. Field of the Invention

The present invention relates to an electrical connector, and more particularly to a backplane connector having a plurality of improved inner shielding plates.

2. Description of the Prior Art

In the manufacture of computers and various other electronic assemblies, daughter boards are commonly connected to mother boards by an electrical connector such as backplane connector. An U.S. Pat. No. 5,433,618, issued on Jul. 18, 1995, discloses a backplane connector having an external shield defining a plurality of longitudinal slots. The backplane connector comprises a plurality of inner shielding plates each provided with a protruding portion coupling with the longitudinal slots. The external shield comprises a pair of opposite projecting patches extending into the longitudinal slot for resisting against the protruding portion. However, the outer shield described above could not provide sufficient resilient force to resist against the inner shielding plate firmly.

Hence, an improved electrical connector is needed to solve the above problem.

### BRIEF SUMMARY OF THE INVENTION

One object of the present invention is to provide an electrical connector comprising an improved inner shielding plate having a spring portion engaging with an outer shield firmly.

The present invention provides an electrical connector comprising an insulative housing defining a plurality of terminal slots, a plurality of terminal modules each having a plurality of terminals fixed therein, an outer shield attached to the insulative housing and a plurality of inner shielding plates. The terminal has a first contacting pin received in the terminal slot. The outer shield comprises a first wall, a second wall extending downwardly from the first wall. The inner shielding plate comprises a first section and a second section, respectively engaging with the first wall and the second wall of the outer shield. At least one of the first section and the second section is provided with a spring portion flexibly engaging with corresponding wall of the outer shield.

Advantages of the present invention are to provide a plurality of inner shielding plates each has a first section and a second section. At least one of the first section and the second section has a spring portion flexibly engaging with the outer shield. Therefore, the inner shield provides sufficient resilient force to resist against the outer shield firmly.

Other objects, advantages and novel features of the invention will become more apparent from the following detailed description of the present embodiments when taken in conjunction with the accompanying drawings.

### BRIEF DESCRIPTION OF THE DRAWINGS

FIG. 1 is an assembled perspective view of an electrical connector in accordance with a first embodiment;

FIG. 2 is a perspective view of the electrical connector as shown in FIG. 1, taken from another aspect;

FIG. 3 is an exploded view of the electrical connector as shown in FIG. 1;

FIG. 4 is another exploded view similar to FIG. 3, taken from another aspect;

FIG. 5 is a cross-sectional view of the electrical connector taken along line 5-5 of FIG. 1;

FIG. 6 is an magnifying view of the electrical connector, as especially labeled in FIG. 2;

FIG. 7 is an assembled perspective view of an electrical connector in accordance with a second embodiment;

FIG. 8 is an assembled perspective view of the electrical connector as shown in FIG. 7, taken from another aspect;

FIG. 9 is an exploded view of the electrical connector as shown in FIG. 7;

FIG. 10 is another exploded view similar to FIG. 9, taken from another aspect;

FIG. 11 is a cross-sectional view of the electrical connector taken along line 11-11 of FIG. 7; and

FIG. 12 is an magnifying view of the electrical connector, as especially labeled in FIG. 7.

### DETAILED DESCRIPTION OF THE INVENTION

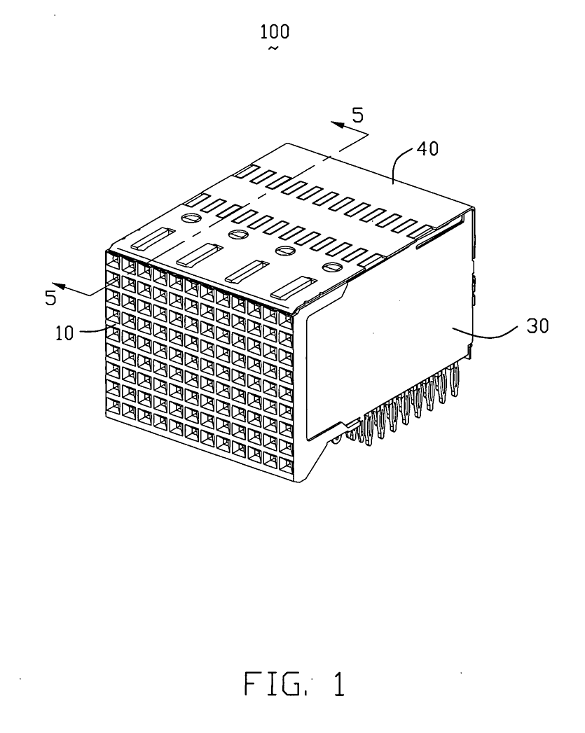

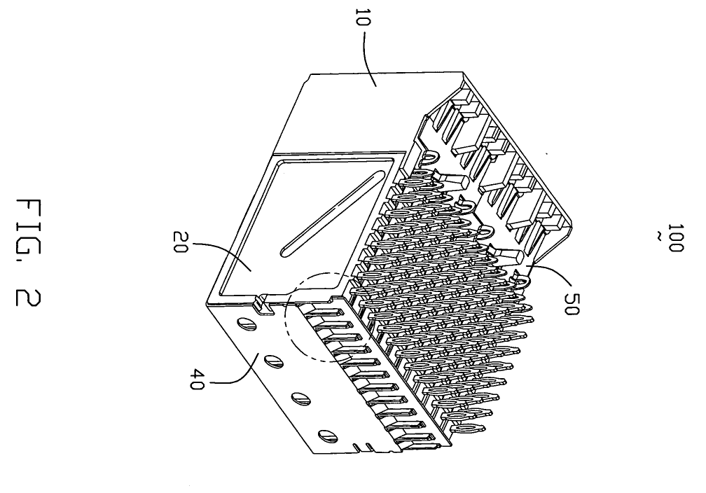

Reference will now be made to the drawing figures to describe the present invention in detail. Referring to FIGS. 1-4, an electrical connector 100 mounted on a printed circuit board (not shown) comprises an insulative housing 10, a plurality of terminal modules 20 each having a plurality of terminals 21 fixed therein, an outer shield 40 attached to the insulative housing 10, a plurality of inner shielding plates 30 engaging with the outer shield 40 and a pair of connection plates 50 mounted to a bottom of the insulative housing 10.

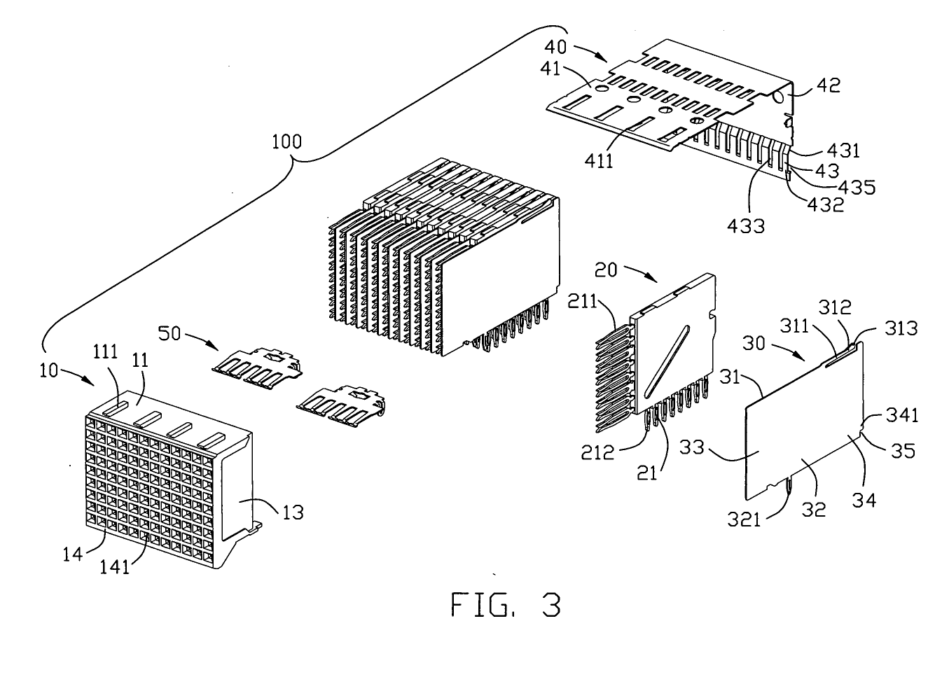

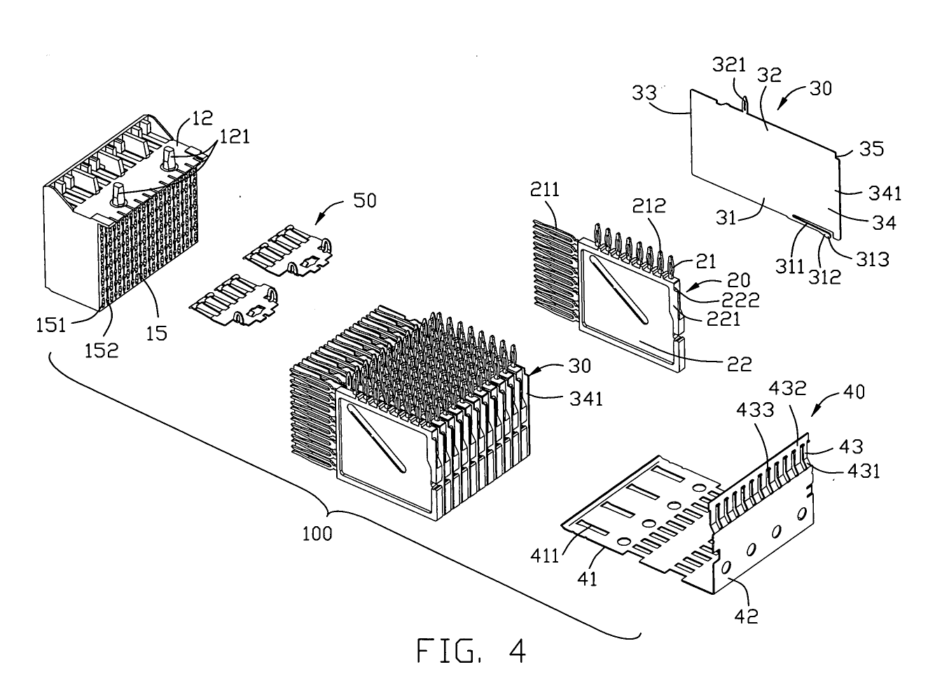

Referring to FIGS. 3 and 4, the insulative housing 10 has a top face 11, a bottom face 12, a pair of opposite side faces 13, a front face 14 and a rear face 15. The top face 11 includes a plurality of protruding blocks 111 for coupling with a plurality of corresponding recesses 411 defined on the outer shield 40. A pair of pegs 121 are disposed on the bottom face 12 to fix the insulative housing 10 to the printed circuit board. The front face 14 is provided with a plurality of first terminal slots 141 extending rearwardly therefrom for engaging with a mating plug (not shown). The rear face 15 defines a plurality of second terminal slots 151 extending forwardly therefrom for communicating with the first terminal slots 141. The insualtive housing 10 further defines a plurality of receiving passages 152 each located adjacent to corresponding second terminal slot 151 for receiving the inner shielding plate 30. The second terminal slots 151 and the inner shielding plates 30, respectively, have a dimension and row direction. In this manner, the terminal module 20 and corresponding inner shielding plate 30 can be located one next to the other.

The outer shield 40 has a first wall 41 extending horizontally, a second 42 extending downwardly from the first wall 41 and a bending portion 43 bending inwardly downwardly from end of the second wall 42 for engaging with the inner shielding plate 30. A plurality of parallel grooves 433 are defined on the bending portion 43 for engaging with the inner shielding plates 30. The bending portion 43 comprises a body section 432 and a medial section 431 extending obliquely and connecting the body section 432 to the end of second wall 42, therefore forming a receiving space 435 between an outer surface of the body section 432 and a lower surface of the medial section 431.

The inner shielding plate 30 is of a rectangular shape and has a first section 31 disposed on a top portion thereof and a second section 34. The second section 34 has a side edge 341 and a stepped portion 35 disposed on an end edge of the side edge 341. The side edge 341 is received in the receiving space 435 and would not project beyond the second wall 42 of the outer shield 40. The stepped portion 35 is of a right-angled shape for engaging with a lower end of the groove 433 of the outer shield 40. The inner shielding plate 30 further comprises a spring portion 312 disposed on the first section 31 thereof and provided with a spring latch 311 and a protrusion 313 disposed on a free end of the spring latch 311 for resisting against the outer shield 40. A plurality of grounding contacts 321 are disposed on a bottom portion 32 of the inner shielding plate 30 and connected to the printed circuit board.

Each terminal module 20 has an insulative frame 22 and a plurality of terminals 21 fixed into the insulative frame 22. The terminal 21 has a first contacting pin 211 extending outwardly horizontally from the insulative frame 22 and received in the second terminal slot 151, a second contacting pin 212 extending outwardly downwardly from the insulative frame 22 and electrically connecting with the printed circuit board. The insulative frame 22 has a bottom board 221 and defines an indention 222 for engaging with the groove 433 of the outer shielding plate 40.

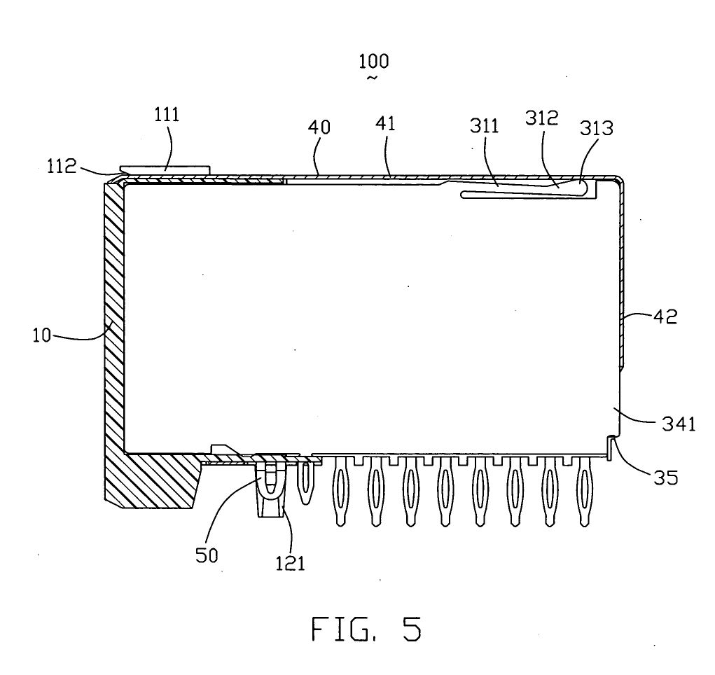

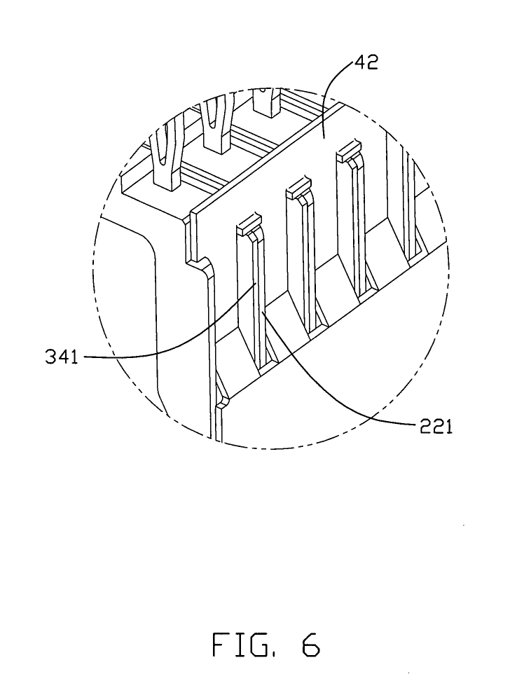

Referring to FIGS. 5 and 6, in assembling of the electrical connector 100, firstly, the terminal modules 20 are inserted into the second terminal slots 151 of the insulative housing 10 in a rear-to-front direction, with the first contacting pins 211 received in the second terminal slots 151. The inner shielding plates 30 are received in the receiving passages 152. Each terminal module 20 and corresponding inner shielding plate 30 are located one next to the other. Secondly, the outer shield 40 is attached to a top portion and a rear portion of the insulative housing 10. The side edges 341 of the inner shielding plates 30 extend throughout the grooves 433 of the bending portions 43 of the outer shield 40 and are completely received within the receiving spaces 435. Each stepped portion 35 of the inner shielding plate 30 has a vertical edge resisted against the body section 432. At this time, the protrusions 313 of the spring latches 311 are abutted against the first wall 41 of the outer shield 40 for firmly fixing inner shielding plates 30 to the outer shield 40. The bottom board 221 of the terminal module 20 is partially resisting against a lower end of the groove 433, and partially extending out of the groove 433. The second contacting pins 212 and the grounding contacts 321 extend downwardly and connect to the printed circuit board. Finally, the pair of connection plates 50 are mounted to the bottom of the insulative housing 10.

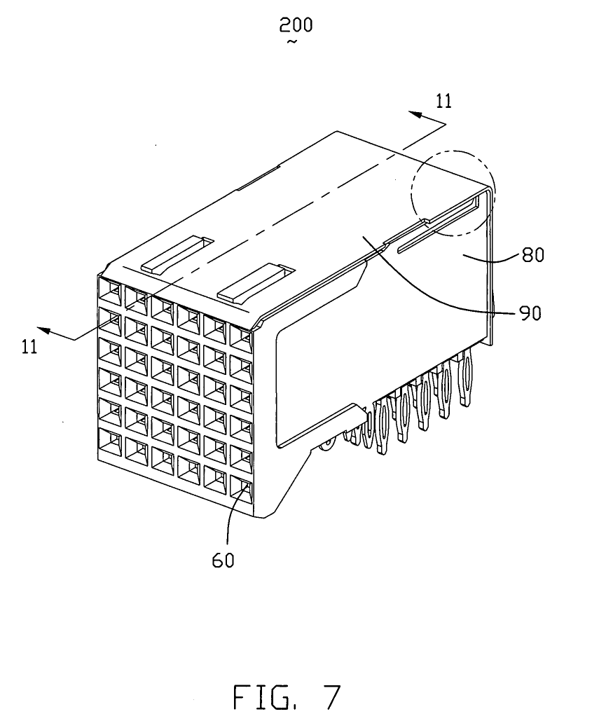

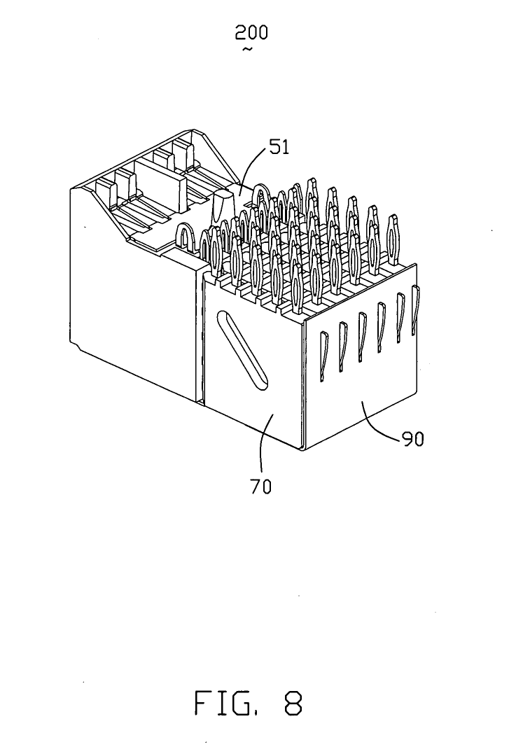

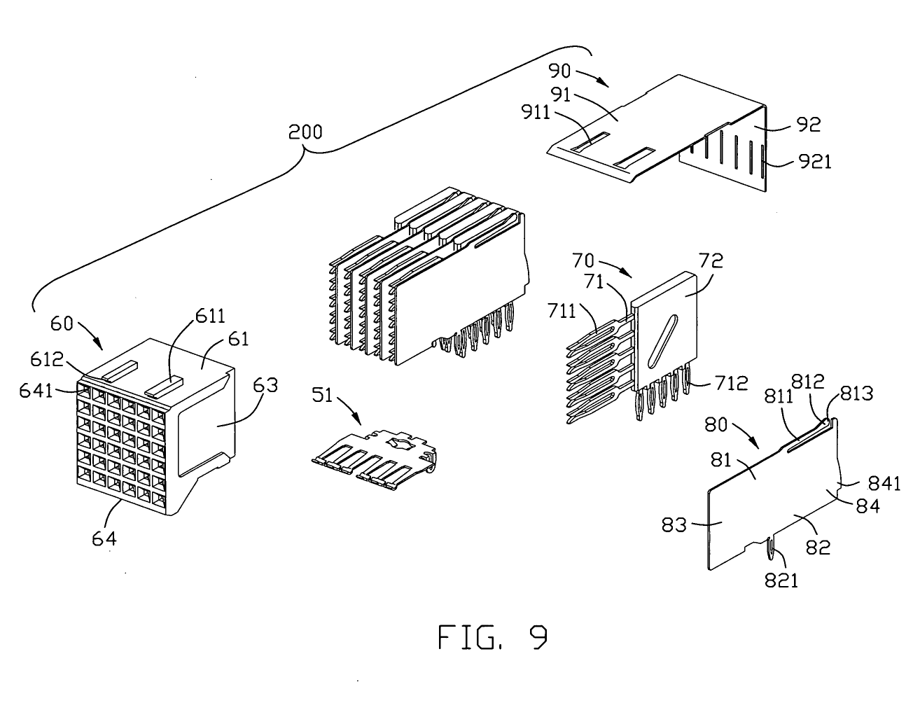

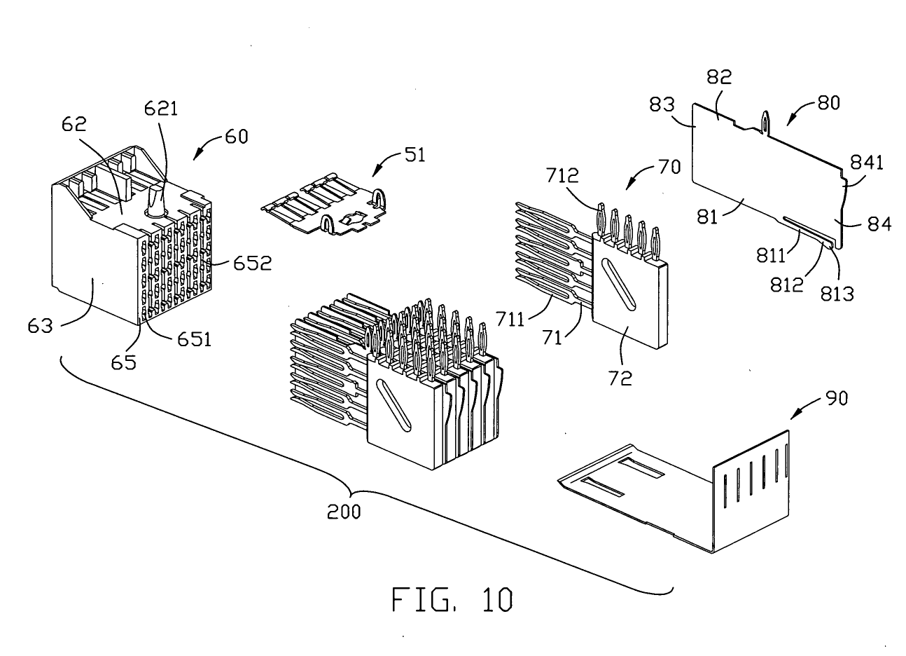

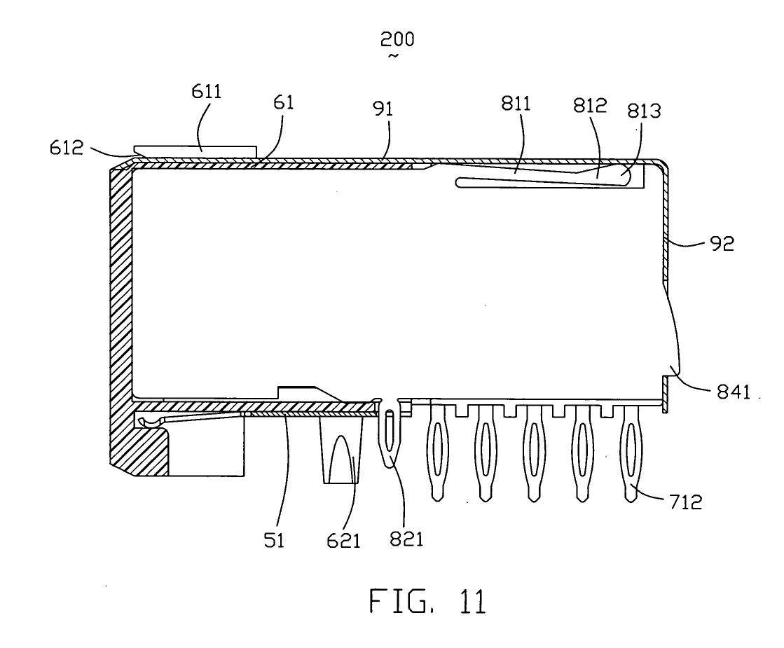

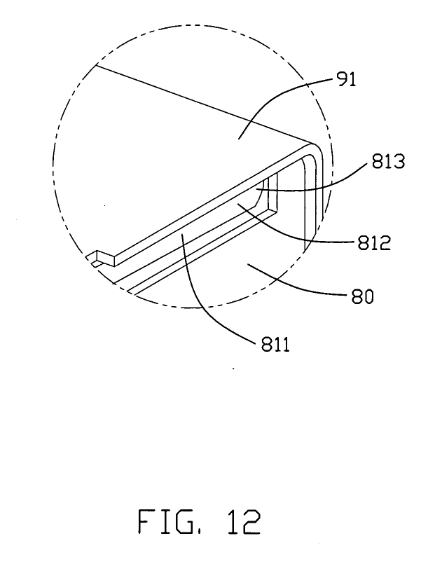

FIGS. 7-12 illustrate a second preferred embodiment of the present invention. In this embodiment, an electrical connector 200 is mounted on a printed circuit board (not shown) comprises an insulative housing 60, an outer shield 90 attached to the insulative housing 60, a plurality of terminal modules 70 each having a plurality of terminals 71 fixed therein, a plurality of inner shielding plates 80 engaging with the outer shield 90 and a connection plate 51 mounted to a bottom of the insulative housing 60.

The inslulative housing 60 has a configuration and structure similar to that of the first embodiment. Detailed description is not illustrated here.

Similarly, the terminal module 70 has an insulative frame 70 and a plurality of terminals 71 fixed into the insulative frame 72. The terminal 71 has a same structure similar to that of the first embodiment and the cooperation between the terminal 71 and the insulative housing 60 and printed circuit board is also same to those disclosed in the first embodiment. Detailed description is thereby omitted.

The outer shield 90 also has a first wall 91 and a second wall 92 extending downwardly from the first wall 91. The first wall 91 defines a pair of recesses 911 for coupling with a pair of corresponding protruding blocks 611 disposed on a top face 61 of the insulative housing 60. The second wall 92 is provided with a plurality of longitudinal grooves 921 thereon for engaging with the inner shielding plates 80. The inner shielding plate 80 has a protruding portion 841 extending laterally and rearward from a side edge thereof and projecting though the longitudinal grooves 921 and beyond the second wall 92.

In other embodiment, the inner shielding plate has a spring latch disposed on a second section thereof for resisting against the second wall of the outer shield.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. An electrical connector mounted on a printed circuit board, comprising:
an insulative housing defining a plurality of terminal slots;
a plurality of terminal modules each having a plurality of terminals fixed therein, each terminal having a first contacting pin received in the terminal slot;
an outer shield attached to the insulative housing and comprising a first wall and a second wall extending downwardly from the first wall; and
a plurality of inner shielding plates each having a first section and a second section respectively engaging with the first wall and the second wall, at least one of the first section and the second section comprising a spring portion flexibly engaging with corresponding wall of the outer shield.

2. The electrical connector as claimed in claim 1, wherein said first section is disposed on a top of the inner shielding plate, and wherein said spring portion of the inner shielding plate is formed on the first section and comprises a spring latch and a protrusion extending from a free end of the spring latch for resisting against the first wall of the outer shield.

3. The electrical connector as claimed in claim 1, wherein said second section is disposed on a side portion of the inner shielding plate, wherein said spring portion is disposed on the second section and comprises a spring latch for resisting against the second wall of the outer shield.

4. The electrical connector as claimed in claim 2, wherein said outer shield has a plurality of grooves defined on the second wall, and wherein the second section of the inner shielding plate comprises a protruding portion projecting laterally from a side edge of the inner shielding plate for engaging with the groove of the outer shield.

5. The electrical connector as claimed in claim 4, wherein said second section of the inner shielding plate further comprises a stepped portion disposed at an end edge of the protruding portion for engaging with a lower end of the groove of the second wall.

6. The electrical connector as claimed in claim 2, wherein said outer shield has a bending portion extending inwardly downwardly from an end of the second wall, said bending portion electrically connecting the inner shielding plates.

7. The electrical connector as claimed in claim 6, wherein said bending portion comprises a body section and a medial section connecting the body section to the end of the second wall to form a receiving space between an outer surface of the body section and a lower surface of the medial section for coupling with a side edge of the inner shielding plate.

8. The electrical connector as claimed in claim 7, wherein said outer shield has a plurality of grooves defined on the bending portion, and wherein the side edge of the second section of the inner shielding plate extend through the grooves and entirely received in the receiving space.

9. The electrical connector as claimed in claim 8, wherein said second section of the inner shielding plate further comprises a stepped portion disposed at an end edge of inner shielding plate for engaging with a lower end of the groove of the bending portion.

10. The electrical connector as claimed in claim 1, further comprising a connection plate mounted to a bottom of the insulative housing.

11. The electrical connector as claimed in claim 1, wherein said first wall of the outer shield defines a plurality of recesses, and wherein said insulative housing is provided with a plurality of protruding blocks on a top portion thereof for coupling with the recesses.

12. The electrical connector as claimed in claim 1, wherein said terminal modules and the inner shielding plates are located one next to the other.

13. The electrical connector as claimed in claim 1, wherein said terminal has a second contacting pin extending downwardly from the insulative housing for electrically connecting with the printed circuit board.

14. An electrical connector comprising:
an insulative housing;
a plurality of juxtaposed terminal modules each having a plurality of terminals fixed therein;
an outer shield attached to the insulative housing and comprising a first wall and a second wall extending downwardly from the first wall; and
a plurality of inner shielding plates each separating every adjacent two terminal modules and having a first section and a second section respectively engaging with the first wall and the second wall, at least one of the first section and the second section comprising a spring portion flexibly engaging with an inner face of a corresponding wall of the outer shield without exposure to an exterior.
